(19) United States
(12) Patent Application Publication
(10) Pub. No.: US 2002/0066229 A1
(43) Pub. Date: Jun. 6, 2002

(54) Device for stopping a door check mechanism in the door open position

(75) Inventor: Richard Rubio, Segoufielle (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, Paris (FR)

(21) Appl. No.: 09/996,729

(22) Filed: Nov. 30, 2001

(30) Foreign Application Priority Data
Dec. 1, 2000 (FR) 00 15601

(51) Int. Cl. E05F 3/00

(52) U.S. Cl. 49/139; 16/66

(57) ABSTRACT

A device for stopping a door of any piece of equipment in the open position is provided with a door check mechanism tending to hold the door in any open position. The device comprises a hollow tube (9) whose diameter is greater than the external diameter of the body (7) of the check mechanism. This tube is positioned coaxially to the check mechanism and is hinged on the axis of the mobile rod (8) of the check mechanism. Its length corresponds to the length of the rod when the door (8) is in the desired open position.

### BACKGROUND OF THE INVENTION

The present invention pertains to a device for stopping a door check mechanism in the open position of the door.

When a piece of equipment has a door that has to be held in the open position to enable access to the interior of this equipment (in order to handle materials, put the equipment into operation, carry out maintenance etc), this door is generally provided with a check mechanism. This check mechanism is hinged by one side on the door and, by the other side, on the door casement. Such a check mechanism can also act as a shock absorber to prevent the door from being closed sharply if a person closing it does not keep hold of it. However, a check mechanism of this kind cannot keep the door open securely regardless of surrounding conditions (for example, if the door is rotating on a horizontal axis, or is very heavy or when there is a gust of wind etc), and this may be hazardous for people who work on equipment provided with doors of this kind.

To stop such a door in the open position, it is possible to envisage a simple mechanical device (for example a hook or shim) solidly joined to a fixed part or resting on a fixed part (the ground, the wall, the frame of the equipment etc). However, such a fixed part is not always near the door and a mechanism of this kind may prove to be cumbersome, bulky and easy to lose. Furthermore, in certain examples of use, it should be possible for the door to be kept ajar, namely in a position that is not fully open. This cannot be done with a fixed hook.

### SUMMARY OF THE INVENTION

An object of the present invention is a device for the stopping a door of any equipment in an open position, the door being provided with a check mechanism tending to hold the door in any open position, this device means easy to make, fit in and handle, and being easy to mount on existing equipment, easy to operate and not cumbersome.

The device according to the invention has a hollow tube whose diameter is greater than the external diameter of the body of the check mechanism, this tube being positioned coaxially to the check mechanism and being hinged on the axis of the mobile rod of the check mechanism, its length corresponding to the length of the rod when the door is in the desired open position.

### BRIEF DESCRIPTION OF THE DRAWINGS

The present invention will be understood more clearly from the following detailed description of an embodiment, taken as a non-restrictive example and illustrated by the appended drawing, wherein:

FIG. 1 provides a partial view in perspective of a door provided with the device according to the invention, in the half-open position, the device of the invention being not yet in the stopping position, and

FIG. 2 provides a view similar to that of FIG. 1, of a door in the open position stopped by the device of the invention.

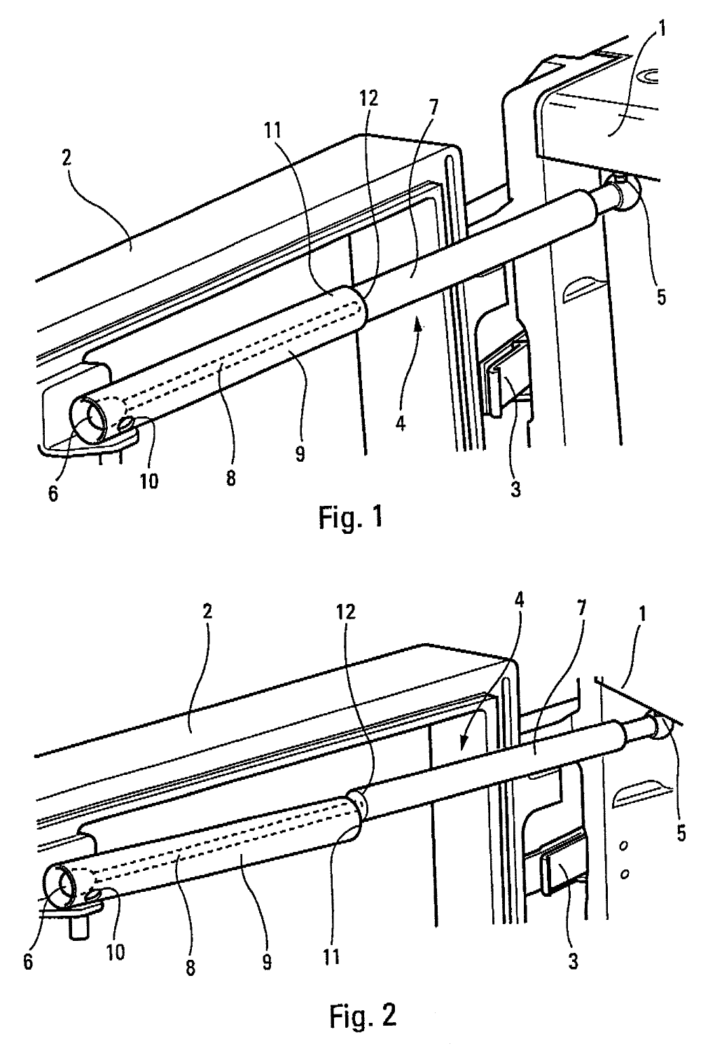

### MORE DETAILED DESCRIPTION

The invention is described here below with reference to the door of a piece of electromechanical equipment. This door rotates about a substantially vertical axis. However, it is clear that the invention is not limited to this application alone and that it can be implemented in many other fields, regardless of the orientation of the rotational axis of the door. Thus for example, it may be a tiltable rear door of an automobile, with a horizontal axis of rotation. Or it may be an armored or non-armored door of a building or vehicle or even any element mobile about an axis cooperating with a pneumatic cylinder or even with a rod assembly hinged at its ends to the door and to a fixed element (or an element considered to be fixed) that has to be stopped in a specified angular position. The invention can also be applied to the stopping of a door or any mobile element in several different specified positions.

The drawing shows a case 1 of a piece of equipment, for example a cabinet containing electronic equipment, and its door 2 mounted on hinges 3. A check mechanism 4 is mounted by one side on a rotational shaft 5 fixed to the case 1 and, by the other side, to a shaft 6 fixed to the door 2. The body 7 of the check mechanism 4 is located on the shaft 5 side while its mobile rod 8 is on the shaft 6 side.

According to the invention, a hollow tube 9 is positioned about the body of the check mechanism 4. The internal diameter of this hollow tube is slightly greater than the external diameter of the body 7 and its length is equal to or smaller than that of the body 7. One of the ends of the tube 9 has a cut-out portion 10 which, for example, is L-shaped. This cut-out portion 10 is used to hook the tube 29 to the shaft 6 while enabling it to follow the rotational motions of the check mechanism about the shaft 6.

When the check mechanism 4 is retracted, namely when the door 2 is closed, the tube 9 surrounds the body 7 of the check mechanism 4 practically throughout its length. When the door 2 is opened, the tube 9, held back by the shaft 6 to which one of the arms of the cut-out portion 10 is hooked, slides on the body 7. When the door 2 is fully open, the tube 9 gets released from the body 7 and falls by its own weight on the rod 8. The free end 11 of the tube 9 (the end opposite the one chosen on the shaft 6) is then in contact with the front face 12 of the body 7 of the mechanism (the front face furthest from the shaft 5) or close to this front face. Naturally, the length of the tube 9, between the shaft 6 and the end 11, is smaller than the length of the rod 8 between the shaft 6 and the face 12 of the body 7, when the rod 8 emerges to the maximum from the body 7. This is the case in order that the tube 9 can get released from the body 7 and fall back on the rod 8. If the door 2 then tends to get closed, the end 11 of the tube 9 abuts the front face 12 of the body 7 and prevents the undesired closing of the door 2. In order to close the door 2 at will, it is enough to raise the end 11 of the tube 9 and pass it into the body 7 while pulling the door shut. The tube 9 can slide on the body 7 and the door 2 can get closed normally.

Naturally, a suitable spring is provided if there is any risk that the equipment provided with the tube 9 might undergo vibrations or tremors. When the door is open, this spring holds the tube 9 against the rod 8. This reinforces the locking of the door in the open position.

It is also clear that the angular opening position of the door from which its locking by the tube 9 occurs is not necessarily its maximum opening position but may be any intermediate angular position between its closed position and its maximum opening position, the length of the tube 9 being reduced correspondingly. In this case, means known per se prevent the door from opening further and/or from oscillating between this half-open position and the fully open position. These means comprise, for example, a spring-operated device that pulls the door shut and therefore firmly applies the end 11 of the tube 9 against the face 12 of the body 7 of the door check mechanism.

According to one variant of the invention, the door may be given several angular locking positions by providing the tube 9 with several stop devices corresponding to these positions. The devices comprise for example pins, each pin moving radially in a sleeve fixed to the tube 9, the sleeves being axially aligned at positions corresponding to the different desired angular positions of the door. As the case may be, a return spring is provided for the door to prevent its oscillations.

What is claimed is:

1. A device for the stopping of a door check mechanism in the open position of the door, wherein the device comprises a hollow tube whose diameter is greater than the external diameter of the body of the check mechanism, this tube being positioned coaxially to the check mechanism and being hinged on the axis of the mobile rod of the check mechanism, its length corresponding to the length of the rod when the door is in the desired open position, the tube getting released from the body and falling on the rod when the door is open.

2. A device according to claim 1, wherein the desired open position is an intermediate position between the closed position of the door and its maximum open position.

3. A device according to claim 2, comprising several intermediate positions.

4. A device according to claim 2 or 3, comprising a spring-operated device that prevents the door from oscillating between its desired position and its maximum open position.

5. A device according to any of the above claims, comprising a spring that holds the tube applied to the mobile rod in the door-open position.
